(19) United States
(12) Patent Application Publication
(10) Pub. No.: US 2006/0093049 A1
(43) Pub. Date: May 4, 2006

(54) Dual antenna communication methods and systems

(76) Inventors: Michael A. Jensen, Springville, UT (US); Michael D. Rice, Provo, UT (US); Norman Thomas Nelson, Spanish Fork, UT (US); Adam L. Anderson, La Jolla, CA (US)

Correspondence Address: STEVEN MCDANIEL, MSEE;REG. PATENT AGENT, 846 S. 1350 E., PROVO, UT, 84606, US

(21) Appl. No.: 11/252,443

(22) Filed: Oct. 18, 2005

Related U.S. Application Data
(60) Provisional application No. 60/620,205, filed on Oct. 19, 2004.

(51) Int. Cl. H04L 27/00

(52) U.S. Cl. 375/259

(57) ABSTRACT

A dual antenna transmitter includes a diversity encoding module that receives a data stream and provides a pair of encoded data streams selected to cause generation of overlapping symbols that provide substantially constant signal power to a receiver when the first and second antennas are unobstructed from the receiver. The diversity encoding module may compensate for the state retention of standard modulators thereby enabling the implementation of the Alamouti transmit diversity scheme. A wireless receiver capable of receiving data transmitted from the aforementioned transmitter includes a metric extraction module that repetitively extracts a metric from a transmitted signal at a selected rate to provide a first and a second metric stream, the first metric stream comprising data that is time offset from data in the second metric stream, the time offset corresponding to a differential time delay to the receiver for symbols emitted from the transmitter antennas.

### RELATED APPLICATIONS

This application claims priority to U.S. Provisional Patent Application No. 60/620,205 entitled “Differential and Non-Differential Space-Time Block Codes for Multi-Antenna Air-Vehicle Communications Using Shaped Offset QPSK and Feher QPSK Modulation” and filed on 18 Oct. 2005 for Michael A. Jensen and Michael D. Rice, which is incorporated herein by reference.

### BACKGROUND OF THE INVENTION

1. Field of the Invention

This invention relates generally to electronic communication system and methods and more particularly relates to systems amd methods to transmit data to a receiver from a dual antenna transmitter.

2. Description of the Related Art

Wireless communications are often conducted under adverse conditions that impose challenges to continuous communication between a transmitter and a receiver. For example, obstruction and self-interference may cause extreme fluctuations in the signal power that reaches a receiver from a particular transmitter. One application that is particularly succeptible to airborne communications.

As depicted in FIG. 1, the fuselage of an aircraft 110 may particularly or completely block a signal 120 transmitted from an antenna 130 from reaching an intended receiver 140. In particular, changes in orientation due to maneuvers may cause frequent loss of signal to the receiver 140. In response to such an issue, many military aircraft have been equipped with dual antennas 130 and 150 positioned to prevent complete obstruction of the transmitted signal 120 from the intended receiver 140.

One unintended consequence of providing dual antennas to an aircraft is self interference due to the relatively large distance between the antennas. For example, as depicted in FIG. 2a, two antennas separated by 10 wavelengths generate a large number of lobes 210 and nulls 220 (i.e. 40 each) as shown in the radiation pattern 230a. The positioning of the lobes 210 and nulls 220 may depend on the data transmitted from the antennas. As a result, an intended receiver may receive erratic signal power when both antennas on a dual antenna transmitter are unobstructed—a rather ironic situation.

Due to the issues involved in maintaining communication between a dual antenna transmitter and a receiver, it is apparent that a need exists for systems and methods to provide substantially constant signal power to a receiver from a dual antenna transmitter and properly decode the received signal.

### SUMMARY OF THE INVENTION

The present invention has been developed in response to the present state of the art, and in particular, in response to the problems and needs in the art that have not yet been fully solved by currently available communication systems and methods. Accordingly, the present invention has been developed to provide systems and methods to communicate to a receiver from a dual antenna transmitter that overcome many or all of the above-discussed shortcomings in the art.

Specifically, the communication systems and methods described herein facilitate providing substantially continuous communication throughput to a receiver from a dual antenna transmitter provided that the receiver is in range and at least one antenna is unobstructed from the receiver. In contrast to previous solutions, where destructive self interference may occur when each antenna is unobstructed, (particularly with antennas separated by multiple carrier wavelengths) the present invention facilitates providing and utilizing substantially constant signal power when each antenna, or a single antenna, is unobstructed.

In one aspect of the present invention, a wireless receiver capable of receiving data transmitted from a dual antenna transmitter includes a metric extraction module configured to repetitively extract a metric from a transmitted signal at a selected rate to provide a first and a second metric stream, the first metric stream comprising data that is time offset from data in the second metric stream, the time offset corresponding to a differential time delay to the receiver for symbols emitted from a first antenna and symbols emitted from a second antenna, and a data estimation module configured to estimate a transmitted data stream from the first and second metric streams. The transmitted signal may include overlapping symbols selected to provide substantially constant signal power to the receiver (i.e. substantially independent of the transmission angle) when the first and the second antenna are unobstructed from the receiver.

The receiver may also include a detection filter configured to filter the transmitted signal and provide a baseband signal. Furthermore, the metric extraction module may include one or more sampling circuits configured to extract the first and second metric streams from the baseband signal. In one embodiment, the extracted metric is a baseband signal amplitude.

In certain embodiments, a channel estimation module measures the differential time delay between symbols emitted from the two antennas. The channel estimation module may also estimate a transfer function for signals emitted from each of the antennas. In one embodiment, various channel parameters are derived by processing one or more training signals.

In another aspect of the present invention, a method to receive data transmitted from a dual antenna transmitter includes receiving a signal comprising a plurality of overlapping symbols emitted from a dual antenna transmitter operably connected to a first and a second antenna, the plurality of overlapping symbols selected to provide substantially constant signal power (i.e. sustained angle independent power) when the first and the second antenna of the transmitter are unobstructed from a receiver, repetitively extracting a metric from the transmitted signal at a selected rate to provide a first and a second metric stream, the first metric stream comprising data that is time offset from data in the second metric stream, the time offset corresponding to a differential time delay for symbols emitted from the first antenna and symbols emitted from the second antenna, and estimating a transmitted data stream from the first and second metric streams.

In one embodiment, the time offset is equal to the differential delay. Estimating the transmitted data stream may include computing a maximum likelihood sequence estimate. In one embodiment, a Viterbi trellis is pruned to estimate the transmitted data.

In another aspect of the present invention, a dual antenna transmitter includes a diversity encoding module configured to receive a transmission data stream and provide a first and a second encoded data stream to a first and a second differential modulator, the first differential modulator configured to modulate the first encoded data stream and provide a first transmission signal to a first antenna, the second differential modulator configured to modulate the second encoded data stream and provide a second transmission signal to a second antenna. The diversity encoding module may be further configured to provide data within the first and the second encoded data streams selected to cause generation of a plurality of overlapping symbols (by the first and second differential modulators) that provide substantially constant signal power to a receiver when the first and second antennas are unobstructed from the receiver.

The first and second differential modulators may be standard differential modulators that substantially conform to an ARTM Tier1 SOQPSK specification. The diversity encoding module may include a modulation compensation module that compensates for the sequence dependent nature of the differential modulator. In certain embodiments, the diversity encoding module is configured to ensure that the plurality of overlapping symbols generated by the differential modulators substantially conform to an Alamouti transmit diversity scheme.

In another aspect of the present invention a method to transmit data from dual antennas to a receiver, includes differentially modulating a first and a second encoded data stream to provide, respectfully, a first and a second transmission signal to a first and a second antenna, and providing data within the first and the second encoded data streams selected to cause generation of a plurality of overlapping symbols when differentially modulated. The overlapping symbols may be selected to provide substantially constant signal power to a receiver when the first and second antennas are unobstructed.

The overlapping symbols generated and processed by the present invention may substantially conform to an Alamouti diversity scheme. The overlapping symbols may also be spectrally shaped to reduce out-of-band noise. In one embodiment, the overlapping symbols substantially conform to the ARTM Tier-1 SOQPSK specification.

In another aspect of the present invention, a system to communicate data to a receiver from a dual antenna transmitter includes a transmitter configured to transmit a plurality of overlapping symbols from a first and a second antenna, the plurality of overlapping symbols selected to provide substantially constant signal power when the first and second antenna of the transmitter are unobstructed from a receiver, and a receiver configured to receive the plurality of overlapping symbols transmitted from the first and second antennas. The receiver may include the aforementioned metric extraction module that repetitively extracts a metric from the transmitted signal at a selected rate and provides a pair of metric streams that are time offset, thereby facilitating estimation of a transmitted data stream from the metric streams.

In one embodiment, the transmitter is placed in an helicopter and the transmitter antennas are positioned to prevent concurrent obstruction by rotors on the helicopter of the first and second antennas from a receiver positioned above the helicopter.

The present invention facilitates maintaining communication throughput to a receiver from a dual antenna transmitter despite changes in orientation of the transmitter such as occurs with an aircraft during test maneuvers. It should be noted that references to features, advantages, or similar language within this specification does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The aforementioned features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic diagram depicting certain prior art issues related to airborne communications;

FIG. 2 is a polar graph depicting a typical dual antenna radiation pattern;

FIG. 3 is a schematic block diagram depicting one embodiment of a communication system of the present invention;

FIG. 4 is a schematic block diagram depicting one embodiment of dual antenna transmitter of the present invention;

FIG. 5 is a schematic block diagram depicting one embodiment of wireless receiver of the present invention;

FIG. 6 is a flow chart diagram depicting one embodiment of a data transmission method of the present invention; and

FIG. 7 is a flow chart diagram depicting one embodiment of a data reception method of the present invention.

### DETAILED DESCRIPTION OF THE INVENTION

Some of the functional units described in this specification have been explicitly labeled as modules, (while others are assumed to be modules) in order to emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

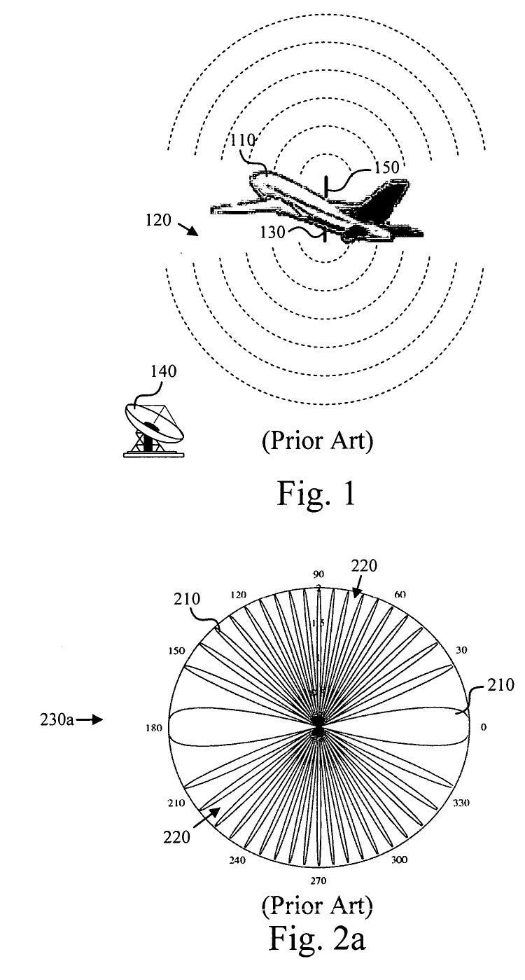

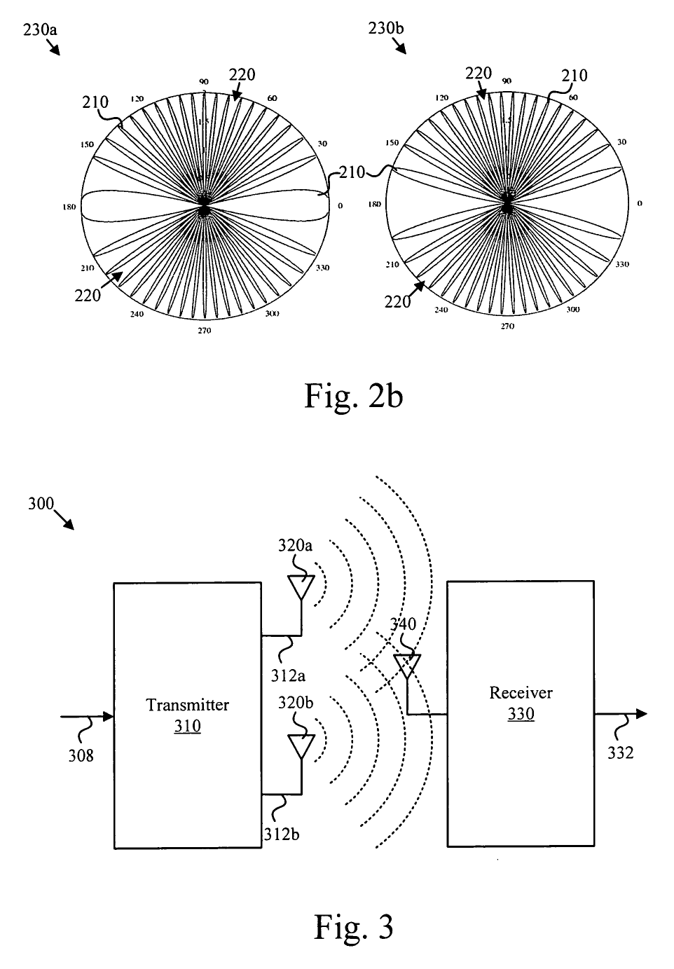

Referring to FIG. 2b, a pair of complimentary radiation patterns such as the radiation patterns 230a and 230b may be alternately emitted from a dual antenna transmitter to provide substantially constant signal power to a receiver. For example, signals comprising streams of symbols may conform to the following Alamouti transmit diversity scheme:

$${r}^{( n )} = [ \begin{matrix}{r}^{( n )} \\ {r}^{( n + 1 ) *}\end{matrix} ] = \frac{1}{\sqrt{2}} \underbrace{[ \begin{matrix}{h}_{1} & {h}_{2} \\ {h}_{2}^{*} & - {h}_{1}^{*}\end{matrix} ]}_{H} \underbrace{[ \begin{matrix}{s}^{( n )} \\ {s}^{( n + 1 )}\end{matrix} ]}_{{s}^{( n )}} + \underbrace{[ \begin{matrix}{η}^{( n )} \\ {η}^{( n + 1 ) *}\end{matrix} ]}_{{η}^{( n )}} , \qquad ( 1 )$$

The superscripts (n) and (n+1) referenced in equation (1) represent a time index while the variables s⁽ⁿ⁾ and s⁽ⁿ⁺¹⁾ represent two consecutive symbols. During symbol time n, antenna #1 transmits symbol s⁽ⁿ⁾ and antenna #2 concurrently transmits s⁽ⁿ⁺¹⁾. During symbol time n+1, antenna #1 transmits −s^{(n+1)*} and antenna #2 transmits s^{(n)*}.

For more detailed information on implementing the Alamouti diversity scheme, the reader is referred to S. M. Alamouti, “A simple transmit diversity technique for wireless communications”, IEEE Journal on Selected Areas of Communications, vol. 16, pp. 1451-1458, October 1998 or M. A. Jensen, M. D. Rice, T. Nelson, A. L. Anderson, “Orthogonal dual-antenna transmit diversity for SOQPSK in aeronautical telemetry channels,” Proceedings of the 40^{th} International Telemetering Conference, paper # 04-11-01, 8 pages, San Diego, Calif., Oct. 18-21, 2004 authored by the Applicants. For general information on digital communications and modulation, the reader is encouraged to refer to “Digital Communications”, 4^{th} edition by John G. Proakis.

Adhering to the Alamouti transmit diversity scheme or a similar scheme provides the possibility of providing coverage equivalent to a single antenna while substantially reducing the probability of complete antenna obstruction given the presence of two antennas. For example, antennas placed opposite one another on the body of an aircraft need not suffer the drawbacks of self interference. Despite these advantages, certain issues addressed by the present invention have heretofore hindered deployment of such diversity schemes.

FIG. 3 is a schematic block diagram depicting one embodiment of a communication system 300 of the present invention. As depicted, the communication system 300 includes a transmitter 310 equipped with dual antennas 320, and a receiver 330 equipped with a single antenna 340. The communication system 300 facilitates leveraging the Alamouti transmit diversity scheme or a similar scheme to provide substantially continuous communication throughput between the transmitter 310 and the receiver 330 when the antennas 320 are unobstructed from the receiver 330 and within communication range.

The transmitter 310 receives a transmission data stream 308 and provides a first stream of symbols 312a to antenna 320a, and a second stream of symbols 312b to antenna 320b. The symbols 312 are selected to provide substantially constant signal power when antenna 320a and antenna 320b are unobstructed from the receiver 330. In one embodiment, the transmitter 310 effectively alternates or varies the radiation pattern (not shown) emitted from the dual antennas 320 during successive symbol transmissions. In such a scenario, the lobes and nulls associated with the radiation pattern may exchange or vary radial positions during successive symbol periods.

In one embodiment, a helicopter (not shown) is equipped with the transmitter 310 and a pair of antennas 320 that are positioned to avoid concurrent obstruction of the antennas 320 by the rotors on the helicopter enabling the transmitter 310 to communicate with a receiver 330 positioned above the helicopter. In one embodiment, a satellite is equipped with the receiver 330 or the like enabling communication over a wide geographic region with land or air vehicles equipped with the transmitter 310. In another embodiment, the receiver 330 may reside on an airplane.

In certain embodiments, the symbols provided by the transmitter 310 are overlapping symbols that are produced before one or more previous symbols have been completely transmitted. The receiver 330 may be configured to decode symbol streams emitted from the dual antennas 320 despite overlapping symbols and short term variations in the radiation pattern. In the depicted embodiment, the receiver 330 measures a differential time delay for symbols emitted from antennas 320a and 320b and repetitively extracts a metric from the transmitted signal at a selected rate in order to extract a pair of metric streams (not shown in this Figure) that are time offset according to the measured differential time delay. Consequently, the receiver may estimate the transmitted data stream 308 from the extracted metric streams and provide a decoded data stream 332 that is substantially identical to the data stream 308.

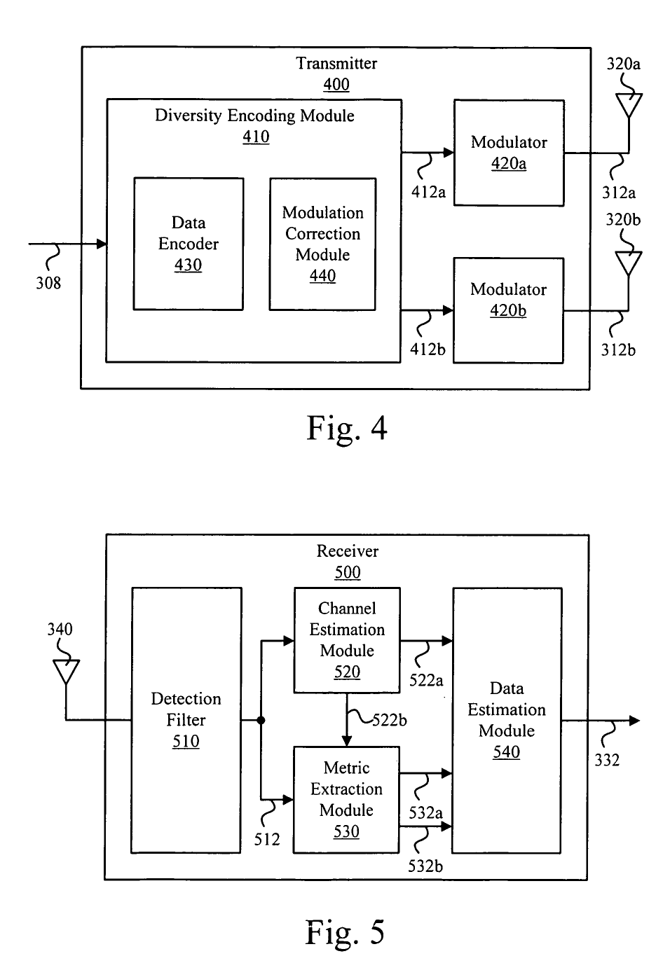

FIG. 4 is a schematic block diagram depicting one embodiment of a dual antenna transmitter 400 of the present invention. As depicted, the dual antenna transmitter 400 includes a diversity encoding module 410, and a pair of modulators 420a and 420b operably connected to a pair of antennas 320a and 320b. The depicted diversity encoding module 410 further includes a data encoder 430 and a modulation compensation module 440. The dual antenna transmitter 400 is one example of the transmitter 310 depicted in FIG. 3.

The diversity encoding module 410 receives a transmission data stream 308 and provides a pair of encoded data streams 412 which ensure substantially constant signal transmission (i.e. directionally independent transmission) from the dual antennas 320. In one embodiment, the diversity encoding module 410 ensures an Alamouti transmit diversity scheme or a similar scheme.

The modulators 420 modulate the encoded data streams 412 and provide a stream of overlapping symbols 312 to the dual antennas 320. In certain embodiments, the modulators retain state information to improve the transmission characteristics of the stream of overlapping symbols 312. For example, the modulators 420 may be differential modulators that substantially conform to the ARTM (Advanced Range Telemetry) Tier-1 SOQPSK (Shifted Offset Quadrature Phase Shift Keying) or FQPSK (Feher Quadrature Phase Shift Keying) specification.

A side effect of retaining state information is an indirect relationship between the data modulated by the modulators 420 and the stream of overlapping symbols 312. Consequently, any relationships established between the data streams that enter a pair of differential modulators may not be preserved in the outgoing stream(s) of overlapping symbols. Furthermore, the data encoder 430 may be a standard data encoder such as a QSPK encoder that is unaware of transmit diversity issues.

In certain embodiments, such as those requiring transmit diversity while using standard encoders and modulators, the diversity encoding module 410 may include a modulation compensation module 440 that compensates for the state retention of the modulators 420. The provided compensation may serve to preserve a direct relationship between the transmission data stream 308 and the stream of overlapping symbols 312. In other embodiments, the data encoder 430 may be configured to directly ensure transmit diversity in the encoded data streams 412 and the symbol streams 312 without a modulation compensation module 440.

FIG. 5 is a schematic block diagram depicting one embodiment of wireless receiver 500 of the present invention. As depicted, the wireless receiver 500 includes a detection filter, a channel estimation module 520, a metric extraction 530, and a data estimation module 540. The wireless receiver 500 is one example of the receiver 330 depicted in FIG. 2.

The detection filter 510 detects a carrier signal upon which symbols emitted from a dual antenna transmitter are encoded and demodulates the carrier signal to provide a baseband signal 512. In one embodiment, the detection filter is a matched filter. The channel estimation module extracts channel information 522 from the baseband signal such as a transfer function for each transmitting antenna, and a differential time delay for symbols emitted from each transmitting antenna. In one embodiment, a complex transfer gain 522a is provided to the data estimation module, and a differential time delay 522b is provided to the metric extraction module. In one embodiment, the channel estimation module includes a training signal detector (not shown) that facilitates measuring a training signal to properly extract the channel information 522.

The metric extraction module 530 receives the differential time delay 522b and provides a pair of metric streams 532 that have a time offset corresponding to the differential time delay 522b. In certain embodiments, the metric extraction module includes a pair of sampling circuits (not shown) driven by offset sampling clocks (not shown) that operate at a multiple of the symbol emission rate. In one embodiment, the time offset is equal to the differential delay time 522b.

The data estimation module 540 receives the metric streams 532, estimates the originally transmitted data, and provides the decoded data stream 332. In certain embodiments, the data estimation module 540 is a maximum likelihood sequence estimator. In one embodiment, the data estimation module 540 is a Viterbi decoder.

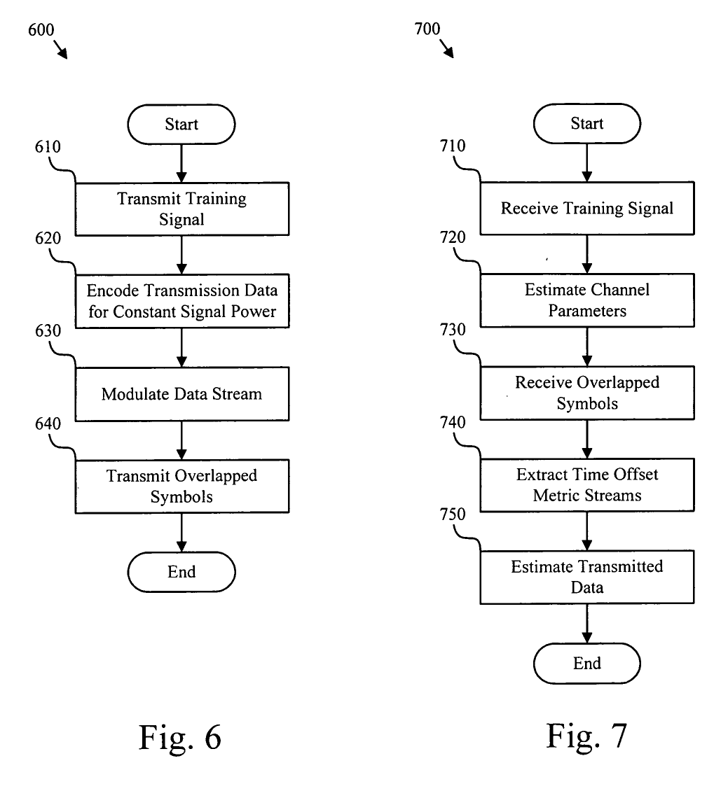

FIG. 6 is a flow chart diagram depicting one embodiment of a data transmission method 600 of the present invention. As depicted, the data transmission method 600 includes transmitting 610 a training signal, encoding 620 transmission data for constant signal power, modulating 630 the encoded data, and transmitting 640 overlapped symbols. The data transmission method 600 may be conducted in conjunction with the dual antenna transmitter 400 or the like.

Transmitting 610 a training signal may include transmitting signals from each antenna that enable measurement of the channel parameters 422. In certain embodiments, the training signal alternates transmission of a training sequence from each antenna enabling a receiver to detect the relative strength of the signal from each antenna as well as any overlap in the received training symbols caused by a differential time delay between the antennas.

Encoding 620 transmission data for constant signal power may include encoding the transmission data to substantially conform to the Alamouti diversity scheme. In one embodiment, the data is encoded to provide Alamouti transmit diversity for a standard SOQPSK modulator thus requiring encoded in-phase and quadrature streams for each modulator.

To illustrate how this can be done, it is useful to review some details associated with the SOQPSK modulation scheme as it might be implemented for transmitting aeronautical telemetry data. Consider a stream of bits C[k] that can assume symmetric binary values +1 or −1, where k represents an integer bit time index which is deliberately distinct from the symbol time index n. The offset between the in-phase and quadrature components inherent with SOQPSK modulation requires the in-phase (I) component of the signal is constrained to change its value only for even values of k=2n, while the quadrature (Q) component of the signal changes its value only for odd values of k=2n+1. This means that the signal can only change its phase by π/2 radians each bit time.

I[k] and Q[k] may take on values of +1 or −1 to represent a quadrature value at bit time k. SOQPSK modulation may be implemented using a differential bit encoding process expressed as:
I[2n]=C[2n] XOR Q[2n−1] (3)
Q[2n+1]=C[2n+1] XOR I[2n] (4)

The XOR operator is an EXCLUSIVE-OR operator for symmetric binary signals such that if A=B, A XOR B=1, or −1 if A≠B. Conducting this procedure naturally creates the offset transitions for the I and Q channels. For each bit (and therefore each I or Q transition), the output of the SOQPSK compatible encoder can be represented using a ternary symbol which takes values from the set [−1; 0; +1]. These values represent a phase change of −π/2, 0, or +π/2, respectively, that occurs for each bit transition. The ternary symbols may be used to modulate the data by convolving a pulse shape with the ternary data So selected to provide certain desired spectral properties.

While the differential SOQPSK bit-to-symbol mapping procedure assists in resolving phase ambiguity at the receiver, the retention of state information does not allow the flexibility to directly transmit the symbols required by the Alamouti scheme. However, by applying a modulation compensation procedure (via the modulation compensation module 440 or the like) the constraints imposed by SOQPSK modulation and the Alamouti transmit diversity scheme may be simultaneously satisfied.

In one embodiment, a relationship is derived for the bits of a transmission data stream 308 that are mapped to traditional QPSK symbols by a standard QPSK encoder 430 and those needed by standard SOQPSK modulators 420. To satisfy the Alamouti transmit diversity scheme the modulation compensation must ensure that the I and Q channels are at the Alamouti specified values at the decision point for the symbol (i.e. after both I and Q have completed their transitions). Using equations (3) and (4), a symbol S[n,m] is transmitted out of antenna m at the end of symbol time (i.e. decision point) n where:
S[n,m]=I[2n,m]+jQ[2n,m]=C[2n,m] XOR Q[2n−1,m]+jC[2n+1,m] XOR I[2n,m] (5)

Separating the inphase and quadrature terms it follows that:
C[2n,m]=−I[2n,m] XOR Q[2n−1,m] (6)
C[2n+1,m]=−I[2n,m] XOR Q[2n+1,m] (7)

Letting the nth symbol be represented as a[n]+jb[n], and imposing the Alamouti diversity scheme yields:
C[2n,1]=−a[n] XOR b[n−1] C[2n,2]=a[n+1] XOR b[n−2]
C[2n+1,1]=a[n] XOR b[n] C[2n+1,2]=a[n+1] XOR b[n+1]
C[2n+2,1]=a[n+1] XOR b[n] C[2n+1,2]=−a[n] XOR b[n+1]
C[2n+3,1]=−a[n+1] XOR b[n+1] C[2n+1,2]=−a[n] XOR b[n] (8)

We now have a direct mapping between the incoming QPSK symbols and the bits feeding the SOQPSK modulators to ensure that Alamouti-encoded symbols are transmitted from the two antennas.

Modulating 630 the encoded data and transmitting 640 overlapped symbols according to the above scheme facilitates providing substantially constant signal power to a receiver over a broad range of angles when at least one antenna is unobstructed from a receiver thus facilitating continuous data communications under a variety of conditions.

FIG. 7 is a flow chart diagram depicting one embodiment of a data reception method 700 of the present invention. As depicted, the data reception method 700 includes receiving 710 a training signal, estimating 720 one or more channel parameters, receiving 730 a stream of overlapped symbols, extracting 740 two or more time offset metric streams, and estimating 750 the transmitted data. The data reception method 700 may be conducted in conjunction with the receiver 500 or the like.

Receiving 710 a training signal may facilitate estimating 720 one or more channel parameters such as a differential delay time and a complex gain for each antenna. Furthermore, knowledge of the differential delay time, facilitates receiving 730 a stream of overlapped symbols and extracting 740 two or more time-offset metric streams wherein the time offset corresponds to the differential delay time. The metric streams 532 shown in FIG. 5 are examples of time-offset metric streams.

Additionally, knowing a complex gain or the transfer function for each antenna and extracting the metric streams 532 facilitates estimating 750 the transmitted data. For example, a maximum likelihood sequence estimate may be conducted that finds the most likely sequence of transmitted data that results in the samples provided by the metric streams 532. In one embodiment, the samples are modeled as x=RHd+v where x is a vector containing interleaved values from the metric streams 532, R is an autocorrelation matrix for the detection filter 510, H is block diagonal matrix containing the transfer gain for signals emitted from each antennas, d is the transmitted data, and v is a noise vector. For more information on the details on implementing this particular model as developed by the Applicants, the reader is referred to SPACE-TIME CODED SOQPSK IN THE PRESENCE OF DIFFERENTIAL DELAYS by Tom Nelson and Michael Rice published in Proceedings of the 40^{th} International Telemetering Conference, San Diego, Calif., Oct. 18-21, 2004.

One of skill in the art will appreciate that within the context of this disclosure, the phrase “substantially constant signal power” refers to the average signal power that is achieved over multiple symbol intervals and the phrase “substantially constant signal power” also implies signal levels that are relatively independent of transmission angle. This contrasts to the prior art which may experience erratic fluctuations from symbol to symbol or changes in transmission angle. One of skill in the art will also appreciate the assumption of substantially omni-directional antennas within the preceding disclosure, and that particular antenna and receiver orientations, positions, and transmission angles that substantially obstruct both transmission antennas from the receiver may significantly reduce the signal power conveyed to a receiver.

The present invention provides improved communication between a dual antenna source and a receiver. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. Furthermore, the inclusion of inferentially referenced elements within various limitations of the following claims such as “configured to receive a signal provided by a dual antenna transmitter” are not intended to limit infringement to parties possessing the inferentially referenced elements such as “the dual antenna transmitter” cited in the example limitation.

What is claimed is:

1. An apparatus to receive data transmitted from a dual antenna transmitter comprising:
a receiver configured to receive a transmitted signal comprising a plurality of overlapping symbols transmitted by a dual antenna transmitter operably connected to a first and a second transmitter antenna, the plurality of overlapping symbols selected to provide substantially constant signal power to the receiver when the first and second transmitter antennas are unobstructed from the receiver;
a metric extraction module configured to repetitively extract a metric from the transmitted signal at a selected rate to provide a first and a second metric stream, the first metric stream comprising data that is time offset from data in the second metric stream, the time offset corresponding to a differential time delay to the receiver for symbols emitted from the first antenna and symbols emitted from the second antenna; and
a data estimation module configured to estimate a transmitted data stream from the first and second metric streams.

2. The apparatus of claim 1, further comprising a detection filter configured to filter the transmitted signal to provide a baseband signal, and at least one sampling circuit configured to extract the first and second metric streams from the baseband signal.

3. The apparatus of claim 2, wherein the metric is a baseband signal amplitude.

4. The apparatus of claim 1, further comprising a channel estimation module configured to measure the differential time delay.

5. The apparatus of claim 4, wherein the channel estimation module is further configured to estimate a transfer function for the first and second antennas.

6. The apparatus of claim 4, wherein the channel estimation module is further configured to process at least one training signal.

7. The apparatus of claim 1, wherein the plurality of overlapping symbols substantially conform to an Alamouti diversity scheme.

8. The apparatus of claim 1, wherein the plurality of overlapping symbols are spectrally shaped to reduce out-of-band interference.

9. The apparatus of claim 8, wherein the plurality of overlapping symbols substantially conform to the ARTM Tier 1 SOQPSK or FQPSK specification.

10. A method to receive data transmitted from a dual antenna transmitter comprising:
receiving a signal comprising a plurality of overlapping symbols emitted from a dual antenna transmitter operably connected to a first and a second antenna, the plurality of overlapping symbols selected to provide substantially constant signal power when the first and the second antenna are unobstructed from a receiver;
repetitively extracting a metric from the transmitted signal at a selected rate to provide a first and a second metric stream, the first metric stream comprising data that is time offset from data in the second metric stream, the time offset corresponding to a differential time delay for symbols emitted from the first antenna and symbols emitted from the second antenna; and
estimating a transmitted data stream from the first and second metric streams.

11. The method of claim 10, wherein repetitively extracting a metric from the transmitted signal comprises filtering the transmitted signal to provide a baseband signal, and sampling the baseband signal.

12. The method of claim 10, further comprising estimating a transfer function for the first and second antennas.

13. The method of claim 12, wherein estimating a transfer function comprises processing at least one training signal.

14. The method of claim 10, wherein estimating the transmitted data stream comprises conducting a maximum likelihood sequence estimate.

15. The method of claim 10, wherein the plurality of overlapping symbols substantially conform to an Alamouti diversity scheme.

16. The method of claim 10, wherein the plurality of overlapping symbols are spectrally shaped to reduce out-of-band noise.

17. The method of claim 16, wherein the plurality of overlapping symbols substantially conform to the ARTM Tier-1 SOQPSK or FQPSK specification.

18. An apparatus to transmit data from dual antennas to a receiver, the apparatus comprising:
a diversity encoding module configured to receive a transmission data stream and provide a first and a second encoded data stream to a first and a second differential modulator;
the first differential modulator configured to modulate the first encoded data stream and provide a first transmission signal to a first antenna;
the second differential modulator configured to modulate the second encoded data stream and provide a second transmission signal to a second antenna; and
the diversity encoding module further configured to provide data within the first and the second encoded data streams that is selected to cause generation of a plurality of overlapping symbols by the first and second differential modulators wherein the plurality of overlapping symbols provide substantially constant signal power to a receiver when the first and second antennas are unobstructed from a receiver.

19. The apparatus of claim 18, wherein diversity encoding module is further configured to ensure that the plurality of overlapping symbols substantially conform to an Alamouti transmit diversity scheme.

20. The apparatus of claim 18, wherein the first and second differential modulators substantially conform to the ARTM Tier1 SOQPSK or FQPSK specification.

21. A method to transmit data from dual antennas to a receiver, the method comprising:
differentially modulating a first and a second encoded data stream to provide a first and a second transmission signal to a first and a second antenna respectively; and
providing data within the first and the second encoded data streams selected to cause generation of a plurality of overlapping symbols that when differentially modulated and transmitted provide substantially constant signal power to a receiver when the first and second antennas are unobstructed from a receiver.

22. The method of claim 21, further comprising encoding the first and second encoded data streams to ensure that the plurality of overlapping symbols substantially conform to an Alamouti transmit diversity scheme.

23. A system to communicate data to a receiver from a dual antenna transmitter, the system comprising:
a transmitter configured to transmit a plurality of overlapping symbols from a first and a second antenna, the plurality of overlapping symbols selected to provide substantially constant signal power when the first and second antenna are unobstructed from a receiver; and
a receiver configured to receive the plurality of overlapping symbols transmitted from the first and second antennas, the receiver comprising a metric extraction module configured to repetitively extract a metric from the transmitted signal at a selected rate to provide a first and a second metric stream, the first metric stream comprising data that is time offset from data in the second metric stream, the time offset corresponding to a differential time delay for symbols emitted from the first antenna and symbols emitted from the second antenna, the receiver further comprising a data estimation module configured to estimate a transmitted data stream from the first and second metric streams.

24. A system to communicate between a helicopter equipped with dual antennas and a receiver, the system comprising:
a helicopter equipped with a first and a second antenna, the first and second antennas positioned to prevent concurrent obstruction by rotors on the helicopter of the first and second antennas from a receiver positioned above the helicopter; and
a transmitter configured to transmit a plurality of overlapping symbols from the first and second antennas, the plurality of overlapping symbols selected to provide substantially constant signal power to a receiver when the first and second antennas are unobstructed from a receiver.

25. The system of claim 24, wherein the transmitter comprises a diversity encoding module configured to encode a transmitted data stream to ensure that the plurality of overlapping symbols conform to an Alamouti transmit diversity scheme.

26. The system of claim 25, further comprising a receiver configured to receive the plurality of overlapping symbols transmitted from the first and second antennas, the receiver comprising a metric extraction module configured to repetitively extract a metric from the transmitted signal at a selected rate to provide a first and a second metric stream, the first metric stream comprising data that is time offset from data in the second metric stream, the time offset corresponding to a differential time delay between symbols emitted from the first antenna and symbols emitted from the second antenna, the receiver further comprising a data estimation module configured to estimate a transmitted data stream from the first and second metric streams.

27. A method to communicate between a helicopter and a receiver, the method comprising:
providing a first and a second antenna on a helicopter, the first and second antennas positioned to prevent concurrent obstruction by rotors on the helicopter of the first and second antennas from a receiver positioned above the helicopter; and
transmitting a signal comprising a plurality of overlapping symbols from the first and second antennas, the plurality of overlapping symbols selected to provide substantially constant signal power to a receiver when the first and second antennas are unobstructed from a receiver.

28. The method of claim 27, further comprising encoding a transmitted data stream to ensure that the plurality of overlapping symbols conform to an Alamouti transmit diversity scheme.
